(19) United States
(12) Patent Application Publication
(10) Pub. No.: US 2015/0142562 A1
(43) Pub. Date: May 21, 2015

(54) METHOD AND APPARATUS FOR COMMUNICATING MESSAGES TO INDIVIDUALS

(71) Applicant: Paul Daniel SHEEDY, Essex (GB)

(72) Inventor: Paul Daniel Sheedy, Essex (GB)

(21) Appl. No.: 14/374,908

(22) PCT Filed: Jan. 30, 2013
(86) PCT No.: PCT/GB2013/050200

§ 371 Date: Jul. 26, 2014

(30) Foreign Application Priority Data
Jan. 30, 2012 (GB) 1201536.8

(51) Int. Cl. G06Q 30/02

(52) U.S. Cl. CPC G06Q 30/0255; G06Q 30/0267
USPC 705/14.53

(57) ABSTRACT

Apparatus is provided for communicating messages to individuals entering a retail establishment. It comprises a remotely readable loyalty card for a user of that establishment including an electronically stored user identity. Wireless interrogation means e.g having a range of at least 1 metre reads the loyalty card as the user enters the establishment. A computer system includes a targeting engine for generating user- specific information and configured to output an electronic message for delivery to a specific mobile station associated with the user and the loyalty card. The mobile station may be a mobile phone and the message may be a text message or an e-mail. A method for delivering customized data items to users of electronic privilege cards is also provided.

### FIELD OF THE INVENTION

This invention relates to a method and apparatus for communicating targeted messages to individuals, e.g. customers at a supermarket or other retail establishment.

### BACKGROUND TO THE INVENTION

US 2009/0289936 (Sheedy et. al, the disclosure of which is incorporated herein by reference) discloses a mobile device for use in processing a transaction which comprises an electronic card, tag, fob or similar small portable device having a stored identity and comprising a housing having vertical and horizontal dimensions of a standard credit card, a tag, a fob or the like, transmitter/receiver means including an RFID transmitter and configured to communicate with a local computer for receiving messages, processor means for receiving, storing and outputting messages, and an output device configured to reproduce messages in visible or audible form. The aforesaid card, tag, fob or similar small portable device may be used in association with apparatus for reading and processing the card, tag, fob or similar small portable device consequent on a transaction involving a user of said card, tag, fob or similar small portable device, said apparatus comprising a reader for electronic remote reading of the stored identity on a card, tag, fob or similar small portable device, a processing station for processing a transaction involving the holder of the card, tag, fob or similar small portable device, a local computer configured to receive the identity read by the reader and transaction information from the processing station, and to cause a message to be transmitted to the card, tag, fob or similar small portable device, and one or more remote computers configured to contain a database of identities and transactions for the cards, tags, fobs or similar small portable devices and to generate messages for storage on the cards, tags, fobs or similar small portable devices, the local computer being configured to alert said remote computer or one of said remote computers on reading of a stored identity, and to supply information for use at said local computer concerning one or more messages to be transmitted to and stored on said card, tag, fob or similar small portable device.

US 2010/0223110 (Slavin) discloses a method for delivering customized data items to users of electronic privilege cards includes receiving a customized data item to be delivered to a user having an electronic privilege card, identifying the electronic device storing the targeted user's electronic privilege card, and transmitting the customized data item to the electronic device. In one embodiment, the data item is an offer or coupon that the user may redeem from an entity associated with the electronic privilege card, such as a retailer or service provider. In another embodiment, the electronic device storing the electronic privilege card is a mobile telephone.

### SUMMARY OF THE INVENTION

A problem with which the invention is concerned is to provide a truly workable system which will enable stores and users to transmit and receive targeted messages with a minimum of disturbance and expense and using so far as possible items which will already be available to and be familiar to them. For that purpose it has been found that specialised loyalty cards having a message receiving facility are not easily acceptable because of problems of expense and battery life. Despite advances in electronics and telecommunications a simple, straightforward and effective system for transmitting individual targeted messages has not been suggested.

Within the field of retail coupon distribution there has been a lack of cohesive strategy on how to provide a digital closed loop coupon system for consumers. In preferred embodiments there is provided a full closed loop, low cost targeted delivery system for coupons and offers at the point of for consumer at the point where they enter a store. The present method and system can be implemented without requiring the user to do anything different or for the retailer to change any of their point of sale (POS) technology. They retailer will need to have “coupons to card” software in place, but many already have this facility.

In one aspect the invention provides apparatus for communicating messages to individuals entering a retail establishment comprising:

a remotely readable loyalty card for a user of that establishment including an electronically stored user identity;

wireless interrogation means for reading the loyalty card as the user enters the establishment;

a computer system including a targeting engine for generating user-specific information and configured to output an electronic message for delivery to a specific mobile station associated with the user and the loyalty card.

The loyalty card may be electronically readable at close range by a user placing it against a reader, as for a card of the well-known Oyster card type. However, it is preferred that no user intervention to permit card reading is needed, for which the card may have a RFID chip having a range of at least 1 metre e.g. 5 metres. The loyalty card may be a passive device powered by RF energy from the wireless interrogation means, so that there are no batteries for a user to replace, and it will last indefinitely with no user intervention.

Suitably the wireless interrogation means includes a pair of coils between which users must pass to enter the establishment and providing RF energy to energise the RFID chip of the loyalty card.

It is also envisaged that a mobile phone may serve as a proxy for a loyalty card, with the loyalty card stored within it, in which case the identity may be read from the mobile phone on entry to the store.

The mobile station that receives the coupons or other offers may be a mobile phone and the computer system may be configured to generate a text message or an e-mail or download a message through an in-store app running on

The invention further provides a method for delivering customized data items to users of electronic privilege cards, the method comprising the steps of:

electronically remotely identifying an electronic device storing privilege card data identifying a user;

electronically selecting data to be delivered to that user, the data being customized to the user; and

transmitting the customized data to an electronic device normally carried by the user and being a device other than that storing the electronic privilege card.

In the above method the electronic device may be a mobile phone.

By combining mobile phones, social media and customer data analytics, the present apparatus and method can deliver tailored, real-time, point of sale offers to consumers when they are most likely to respond. In embodiments on detection of a loyalty card, its individual associated purchase history is digitally accessed so that the user can be directly sent a targeted selection of digital coupons. In some embodiments the communication process is automated and the users and store staff do not need any technical knowledge for the process to operate. The method can operate simply on detection of an electronic loyalty card and its associated identity and there is no need for special mobile apps, geo-location, Bluetooth or NFC enabled phones, although the use of these remains an option for those users who prefer them. A user's digital cell phone or smartphone may ion some embodiments automatically receive a SMS txt message on entry to a store. The user can receive the offers on entry to the store and to redeem their targeted offers the customer simply scans their loyalty card at the till as normal. Offers are automatically redeemed. There is therefore no change in consumer behaviour and store staff do not have to manually reconcile cash positions and coupons to total till purchases.

### BRIEF DESCRIPTION OF THE DRAWINGS

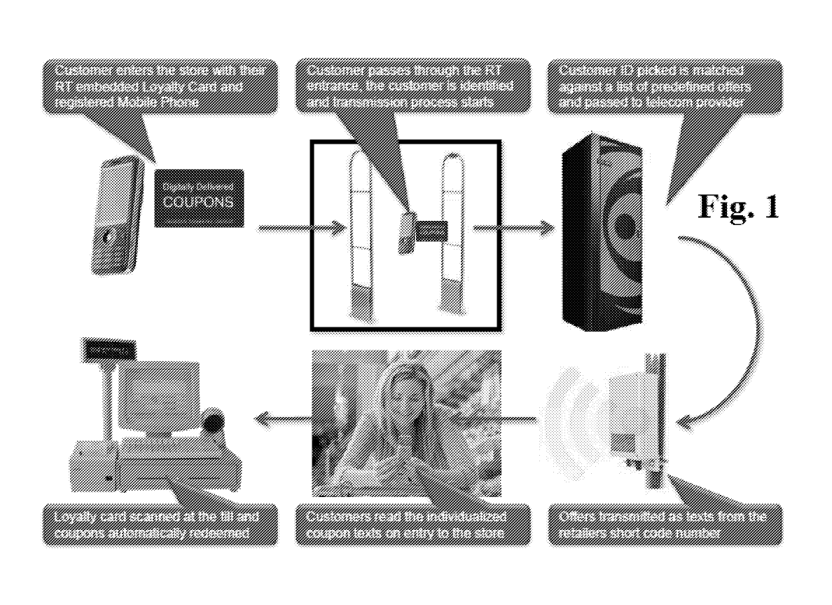

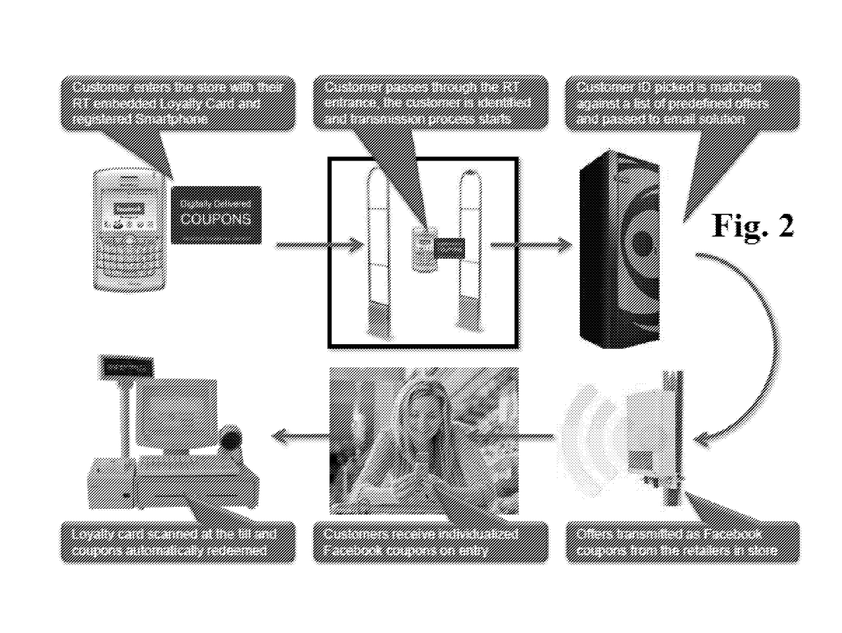

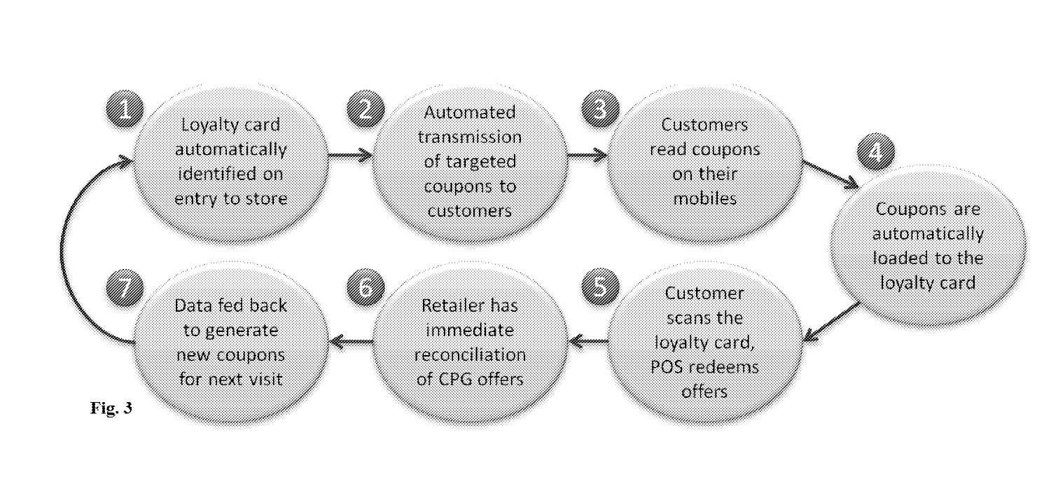

How the invention may be put into effect will now be described by way of example only with reference to the accompanying drawings in which FIG. 1 shows delivery of a text message to a mobile phone, FIG. 2 shows delivery to a smartphone e.g. using an e-mail or social networking service and FIG. 3 is a flowchart.

### DESCRIPTION OF PREFERRED EMBODIMENT

The evolution of mobile phone and smartphone technology suggests that communication to customers through this medium could be a logical choice for the future. However even with recent technical breakthroughs the ability to communicate the right offers to the right customer in the right place is nearly impossible without a degree of technical sophistication that most users do not possess. The applicants have been extensively involved researching digital couponing and devised a workable system for automatically delivering digital coupons with little or no customer interaction at the point of entry to A store. Their solution does not require geo-location enabled phones, triangulation of handsets from Telco providers, apps, upgrades of software changes to handsets, major installation of store hardware and does not create significant issues for staff at the till.

In particular, applicants have identified two clear communication methods to satisfy most customers' needs. They can choose to have coupons delivered by texts for normal cell phones, or through e-mail/social media or store apps to their smartphones. A customer has the option over which method he or she requires when that customer is upgraded to a new loyalty card.

In an embodiment, customer identities are recorded in computer-recognisable form e.g. as encrypted alphabetical, alphanumeric or numeric strings on smart loyalty cards incorporating RFID tags or chips and incorporating transmission antennae. Suitable cards which can store user identities in non-volatile memory are made by Idesco (www idesco.fi) e.g. their EPC card incorporating an EPC C1G2 ISO 18000-6C chip working at 865-868 MHz with a typical operating distance of 4 metres or their similar EPC MIFARE card using a EPC C1G2 ISO 18000-6C, Mifare 1K S50 chip. Other chips are made by Alien Technology of Morgan Hill, Calif. and are sold under the designation Higgs-3 IC. Higgs-3 operates at extremely low power levels, yet still provides sufficient backscatter signal to read tags at an extended range. It can be programmed at low RF power and at high speed. It is implemented in a low cost CMOS process and uses EEPROM technology. User memory can be read and or write locked on 64-bit boundaries, supporting a variety of public/private usage models. The IC also has a factory programmed 64-bit serial number that cannot be altered and which in conjunction with the EPC code, provides a unique “fingerprint” for a tagged item. There may be employed tags and antennae such as are incorporated into the ALN-9662 “Short” RFID inlay which delivers EPC Gen 2 performance. The loyalty card will, of course include identification information readable at a till and including e.g. a magnetic stripe, a data chip or a one or two-dimensional barcode.

As shown in the attached drawings reading can be as a person carrying a loyalty card of the kind set out above passes between a pair of detection loops at the entrance of the supermarket or other establishment visited or through another RF-enabled zone. Such loops may be on a pair of pedestals at the doorway of the establishment between which customers must pass, or may be concealed in the walls, on the floor or in or below a ceiling of the establishment. Electromagnetic energy from the coils activates the tag and the coils also permit detection of the returned identity information. In another embodiment there may be used a passive long-distance RFID reader e.g. of the kind available from IDESCO operating at UHF e.g. 865-868 MHz. As a default the reader uses only its internal antenna for reading the tags. As an option it can work with a single external antenna or it can use both external and internal antennas. When using two antennas, the both antennas can transmit and receive at the same time or one antenna can transmit while the other is receiving. Reading distances are 3-5 metres and output is via standard interfaces e.g. Ethernet, RS-485 or RS-232. The reader uses Wiegand and RS-232 output format. The length of EPC ID number sent to RS232 communication line depends on the tag used and e.g. it might be a 34-bit output string.

The system for the communication solution to phones triggered by the UHF card being picked up at the point of entry to the store may follow the process below. The card reader passes a detected card identifier to a card recognition application via its serial communication port. A scanner software package triggers an automated response process (allowing monitoring to continue whilst initial card is processed). The card number is validated, formatted into a prewritten SQL statement and passed to an application database. That database returns a single data row as card number is located (no rows returned if record not found), containing customer name, contact preference, email/telephone number (dependent on communication preference) and a flag indicating if contact if allowed at that point (24 hour rule). If the card is not recognised no database record will be returned.

When an identity has been detected it is also matched against a database of customer identities, shopping habits and available offers forming part of a targeting engine within a computer system of a supermarket or chain thereof. An early reference disclosing the provision of customised data to subscribers is US 2003/0208754 (Sridhar), see also U.S. Pat. No. 7,599,858 (Grady), U.S. Pat. No. 7,801,843 (Kumar), U.S. Pat. No. 7,949,553 (Wisniewski) and US 2009/0177540 (Quatse, YT Acquisition Corporation). Suitable targeting engines are available from a number of sources including the present applicants. Offers tailored to the user visiting the establishment are output from the targeting engine.

If the card is identified and found to be contactable, data representing offers to be supplied to the user is then passed to a telecom provider and supplied to a mobile station carried by the user and accessible through a switched network e.g. a mobile phone, intelligent phone or similar device.

For example in FIG. 1 offers are transmitted as texts from the retailers short code number. A SMS message is formatted with personalized information. A customized URL string is created containing recipient details, message and other account specific information, an Internet URL request is made using custom URL string, transmitting SMS requirements to a third party communications provider, and an application display may be updated with a message advising communication relayed.

FIG. 2 is similar except that offers are e-mailed and transmitted e.g. as social media coupons. A SMTP communication object connection may be established to the corporate mail server, an e-mail message may be formatted with personalized information, an e-mail object may be configured with recipient details and message, and the e-mail transmitted to corporate mail server for processing and delivery. An application display may be updated with a message advising that a communication has been relayed. Customers can read the individualized coupon texts on entry to the store.

On completion of shopping the loyalty card is scanned at the till and coupons automatically redeemed. In embodiments when the loyalty card is scanned/swiped/read at the till the coupons have already been loaded to the card, so that the offers can be redeemed automatically. Such a process is already known and is used by retailers such as Safeway and Kroger as well as many others, at present normally only when customers visit websites and select offers available to anyone as opposed to targeted offers. Customers will have have already registered their cards and once they have selected the offers that they need they sign out and the offers are loaded/associated to the card number. Once in the store the customers can redeem them automatically at the till. Some websites that have load to card solutions are: www.cellfire.com, www.coupons.com and http://www.coupons.com/couponweb/help/s2c/source/FAQs.html

Text coupons can be delivered in two ways, first a text with the coupons as already outlined or secondly a text requiring a response or acceptance by the customer that they have viewed or wish to view the offers. This optional, but in some embodiments preferred, function is to establish to the coupon supplier that the customer has viewed their coupon in the store, not later at home after the event. It is advantageous in some embodiments, for example, to ensure that the offers sent by text for example are delivered when the customer activates the offers. In this way there is electronic response whose record can show the time the customer read the offer and it can be established that the customer is in-store. In some embodiments offers are only loaded to the user's mobile phone or other mobile device after activation by the customer. The same goes for the social media, app or email solutions: it is important that the customer clicks to view the offers that have been transmitted so that there is some electronic record that they have been read at the appropriate time and place.

A sequence of operations in the present method is illustrated in FIG. 3. The store will have an area network on which a server stores coupon to card software configured to store inter alia a database of loyalty card information and associated mobile device information defining for each loyalty card identity both the identity of the associated mobile device to which electronic coupons are to be transmitted and the format of transmission to the mobile device (e.g. SMS, page for display e.g. using a store app or social media coupon). At step 1 the loyalty card is automatically detected on entry to the store. The detected entry event is then notified to the coupon to card software which selects targeted coupons for that customer and transmits them electronically at step 2 to the mobile phone, smartphone or other device. The initial transmission in some embodiments is merely an indication that offers relating to consumer packaged goods (CPG) are available and the customer is prompted to return an affirmative indication that he or she wishes to review the coupons before they are transmitted electronically to the mobile device and the user can read them as at step 3. On transmission of the read coupons they are also loaded to the loyalty card and stored at a network server as at step 4. The user selects goods from the store and checks out at a point of sale terminal, making the loyalty card available for scanning, in which case any coupons for offers relating to selected goods are redeemed at step 5. The retailer can reconcile the coupons and CPG coupon offers at 6 and the resulting data is fed back at 7 to the coupon to card software at 7 for use in generating further targeted coupons for offer to the user of the loyalty card at the next visit to the store e.g. using Bayesian-type inferences concerning the user's shopping patterns. Closed loop feedback based on the coupons transmitted to user mobile devices and the actual pattern of purchases, especially where the user is prompted to signal that download of the coupons is wanted, improves customer engagement, enables the retailer to target promotions more effectively and to assess success levels, permits targeted offers to be sent according to the time of day in real time and with appropriate software enables individual stores to implement immediate over-stock offers. User messages may contain an indication of the value of the coupons offered and redeemed to date, and at the retailer detailed reports on coupon redemption rates are available in a matter of hours rather than weeks as with paper systems.

It will be appreciated that various modifications may be made to the embodiments described above without departing from the invention the scope of which is defined by the appended claims.

1. Apparatus for communicating messages to individuals entering a retail establishment comprising:
a remotely readable loyalty card for a user of that establishment including an electronically stored user identity;
wireless interrogation means for reading the loyalty card as the user enters the establishment;
a computer system including a targeting engine for generating user-specific information and configured on reading of the loyalty card to output an electronic message for delivery to a specific mobile station associated with the user and the loyalty card.

2. The apparatus of claim 1, wherein the loyalty card includes a RFID chip having a range of at least 1 metre.

3. The apparatus of claim 2, wherein the RFID chip has a range of about 5 metres.

4. The apparatus of claim 1, wherein the loyalty card is a passive device powered by RF energy from the wireless interrogation means.

5. The apparatus of claim 1, wherein the wireless interrogation means includes a pair of coils between which users must pass to enter the establishment.

6. The apparatus of claim 1, wherein the mobile station is a mobile phone.

7. The apparatus of claim 6, wherein the computer system is configured to generate a text message.

8. The apparatus of claim 6, wherein the computer system is configured to generate an e-mail.

9. A method for delivering customized data items to users of electronic privilege cards, the method comprising the steps of:
electronically remotely identifying an electronic device storing privilege card data identifying a user;
electronically selecting data to be delivered to that user, the data being customized to the user; and
transmitting the customized data to an electronic device normally carried by the user and being a device other than that storing the electronic privilege card.

10. The method of claim 9, wherein electronic remote identification is by a reader located at an entrance to a retail establishment for reading the electronic device locally as the user enters the establishment.

11. The method of claim 9, wherein the electronic device on which the data is stored is an electronic loyalty card.

12. The method of claim 9, wherein the electronic device on which the data is stored is a mobile phone storing an electronic loyalty card.

13. The method of claim 9, wherein the electronic device to which the data is transmitted is a mobile phone.

14. The method of claim 13, wherein there is transmitted to the electronic device a first message indicating the availability of the customised data and requesting a response, and on receipt of the response by a network server a second message is transmitted containing the data.

15. The method of claim 9, wherein the data relates to coupon offers for consumer packaged goods (GPGs).

16. The method of claim 15, wherein the data is transmitted in SMS form.

17. The method of claim 15, wherein the data is transmitted via a store application program (app) resident on the electronic device.

18. The method of claim 15, wherein the data is transmitted as a social media coupon.
